(19) United States
(12) Patent Application Publication
(10) Pub. No.: US 2010/0030848 A1
(43) Pub. Date: Feb. 4, 2010

(54) Client-server system and server machine

(75) Inventor: Shigeru Hidesawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/453,003

(22) Filed: Apr. 27, 2009

(30) Foreign Application Priority Data
Jul. 29, 2008 (JP) 2008-195294

(51) Int. Cl. G06F 15/16

(52) U.S. Cl. 709/203

(57) ABSTRACT

A server machine includes a coordinating section which generates inquiry data representing a content of an inquiry from a user of the client machine, item data indicating a relation between the inquiry and an explanatory item in a manual of the client machine, database in which a user ID identifying a user and count data representing a number of times of the inquiry, and receives an instruction signal instructing transmission of the count data from the client machine to transmit the count data, and the client machine includes a manual storage section storing manual data and a manual manager section which change an arrangement order of each of the explanatory items according to the number of times represented by the count data.

### CROSS-REFERENCE TO RELATED APPLICATION(S)

This application is based upon and claims the benefit of priority of the prior Japanese Laid-open Patent No. 2008-195294, filed on Jul. 29, 2008, the entire contents of which are incorporated herein by reference.

### FIELD

The embodiments discussed herein relate to a client machine performing processing in response to a user's operation and a client-server system including the client machine and a server machine which is capable of communicating with the client machine.

### BACKGROUND

In recent years, electronic manual systems each displaying a manual explaining how to handle a computer or the like according to manual data representing the manual are popularly used as disclosed in, for example, Japanese Laid-Open Patent Publication Nos. H10-63682, 2002-117213 and 2006-140590. In an electronic manual system of this type, the manual data is stored in the computer itself or the server machine or the like are capable of communicating with the computer. In the computer or the like, the manual represented by the manual data is appropriately displayed on a monitor in response to a user's operation. The electronic manual system can dispense with a physical space for storage that is required for the manual or the like in the form of a paper medium. Furthermore, the electronic manual system can easily update a description content of the manual by update or the like of the manual data.

Meanwhile, manuals dealt within most of electronic manual systems of this type are often intended to explain how to handle a multifunction device such as a computer and description contents of each manual are diverse and enormous in amount. On the other hand, interest of a user referring to such a manual is limited by contents or the like of processes performed by the user. While the user's interest often differs among users, the interest is constant for each user in many cases. Due to this, it is required for each user to search the same description content from among the enormous amounts of description contents of the manual displayed on the monitor of the electronic manual system. In this way, the manual dealt with in the electronic manual system is actually disadvantageously difficult, in most cases, for each user to refer to.

### SUMMARY

The present invention has been made in view of the foregoing. It is an object of the present invention to provide an electronic manual system facilitating user's referring to a manual.

According to an basic aspect of the invention, a client-server system includes:

a client machine that performs a process in response to an operation of a user; and

a server machine that is capable of communicating with the client machine,

wherein the server machine includes:

an inquiry data receiving section that receives, from a reception which receives an inquiry about how to handle the client machine from a user of the client machine, inquiry data representing a content of the inquiry, item data indicating which explanatory item of a plurality of explanatory items in a manual the inquiry relates to, the manual explaining how to handle the client machine, and client link data leading to an identification of the client machine;

an inquiry recording section that records the inquiry data with the item data and the client link data such that the inquiry data, the item data and the client link data are associated to one another;

a count data generation section that generates count data indicating a number of times of the inquiry for each of the plurality of explanatory items with respect to the client machine based on the inquiry data, the item data and the client link data;

an instruction signal receiving section that receives from the client machine an instruction signal which instructs transmission of the count data with respect to the client machine identified by the client link data, together with data which identifies the client machine; and

a count data transmission section that transmits the count data to the client machine identified by the client link data, and

wherein the client machine includes:

a data recording section that records explanatory statement data representing respective explanatory statements in each of the plurality of explanatory items and arrangement order data representing an arrangement order of each of the explanatory statements;

a display section that displays the explanatory statements each represented by the respective explanatory statement data according to the arrangement order represented by the arrangement order data;

an instruction signal transmission section that generates the instruction signal and transmits the instruction signal to the server machine, while identifying the client machine itself;

a count data receiving section that receives the count data transmitted from the server machine according to the instruction signal; and

an arrangement order change section that changes the arrangement order data in the data recording section to the arrangement order data representing an arrangement order according to the number of times represented by the count data.

A basic aspect of this client-server system is an electronic manual system displaying a manual represented by the explanatory statement data and the arrangements sequence data and explaining how to handle the client machine on a display section of the client machine. According to the basic aspect of this client-server system, the client-server system can be used to move up a arrangement order of an explanatory statement corresponding to an explanatory item for which the number of inquiries made by a user of the client machine is larger and in which the user feels greater interest to be arranged at a higher position in the arrangement order and to emphatically display the explanatory statement to be arranged at the higher position on the display section. According to such practical use, the user of the client machine can easily locate the explanatory statement corresponding to the explanatory item in which the user feels great interest. That is, according to the basic aspect of this client-server system, the electronic manual system facilitating user's referring to a manual can be obtained.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a client-server system according to a specific embodiment for explaining a basic aspect of the client-server system;

FIG. 2 is a diagram illustrating an example of manual data stored in a manual data storage section illustrated in FIG. 1;

FIG. 3 is a diagram illustrating a manual composed based on the manual data illustrated in FIG. 2;

FIG. 4 is a flowchart illustrating an update processing performed on hierarchical data in the manual data stored in the manual data storage section illustrated in FIG. 1;

FIG. 5 is a diagram illustrating manual data after change when an arrangement order of the default manual data illustrated in FIG. 2 is changed by update of the hierarchical data; and

FIG. 6 is a diagram illustrating a manual composed based on the manual data after update of the hierarchical data illustrated in FIG. 5.

### DESCRIPTION OF EMBODIMENTS

A specific embodiment according to a client-server system whose basic aspect is described above will be described hereinafter with reference to the drawings.

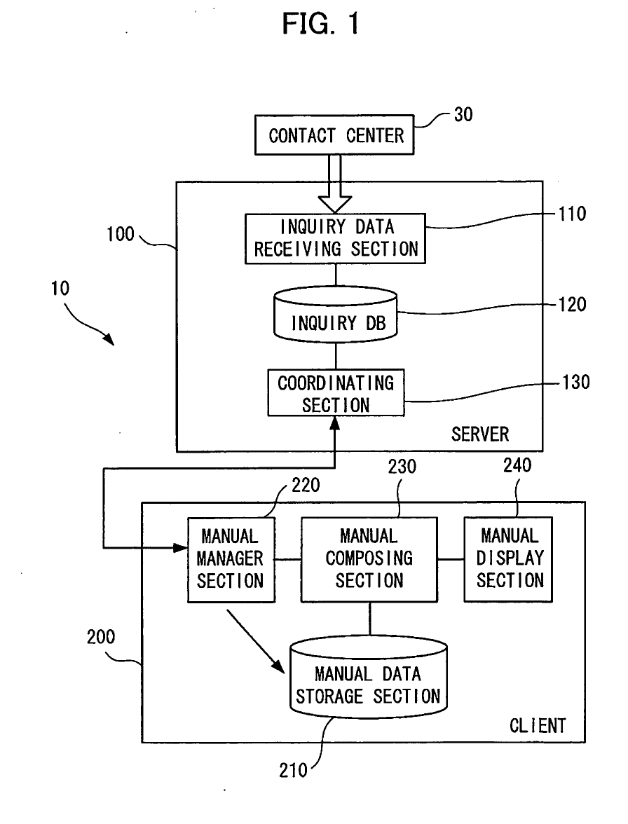

FIG. 1 is a pattern diagram illustrating a client-server system according to the specific embodiment for explaining the basic aspect of the client-server system.

A client-server system 10 illustrated in FIG. 1 includes one server machine 100 and plural client machines 200 that are communicably connected to the server machine 100 and that are equivalent computers to one another. FIG. 1 typically illustrates one of the client machines 200. Furthermore, FIG. 1 illustrates a contact center 30 in which an operator receives an inquiry about how to handle each client machine 200 from a user of the client machine 200 by telephone or the like. The server machine 100 is communicably connected to a computer, not illustrated, installed in this contact center 30. Each client machine 200 is a computer that can execute processes independently of the server machine 100.

In this embodiment, machine ID data for identifying each client machine 200 is allocated to each client machine 200 belonging to the client-server system 10 illustrated in FIG. 1. The machine ID data of each of the client machine 200 is stored in a memory, not illustrated, provided in the client machine 200.

In the client-server system 10 illustrated in FIG. 1, user ID data for identifying a user of each client machine 200 is also allocated to the user. In this embodiment, pieces of user ID data on respective users are stored collectively in a memory, not illustrated, provided in the server machine 100 illustrated in FIG. 1. In this memory, the user ID data on each user is stored to correspond to the machine ID data on the client machine 200 used by the user.

Due to this, in this embodiment, whichever the machine ID data or the user ID data is used, each client machine 200 belonging to the client-server system 10 can be identified. The machine ID data and the user ID data in this embodiment correspond to an example of client link data according to the basic aspect described above.

In this embodiment, an electronic manual system displaying a manual explaining how to handle each client machine 200 on a monitor, not illustrated, of the client machine 200 is incorporated in the client-server system 10. Namely, manual data representing a manual is stored in each client machine 200 in a manner to be described later, and the manual is displayed on the monitor of each client machine 200 in response to a user's operation.

In this embodiment, during display of this manual, the manual is displayed so that an explanatory statement corresponding to an explanatory item in which the user of each client machine 200 feels greater interest and for which the contact center 30 receives a number of inquiries from the user of the client machine 200 is emphatically displayed at a higher position in a manual arrangement. By doing so, the manual is displayed on the monitor of each client machine 200 in a state in which the user of the client machine 200 can easily refer to the manual.

Such a manual display function of the client-server system 10 is obtained by a configuration described below.

The server machine 100 illustrated in FIG. 1 includes an inquiry data receiving section 110 receiving from the contact center 30 inquiry data representing a content of each inquiry transmitted to the contact center 30, an inquiry database 120 recording therein the inquiry data or the like and a coordinating section 130 exchanging various kinds of information between this server machine 100 and each client machine 200. Each client machine 200 includes a manual data storage section 210 storing therein manual data representing the manual of the client machine 200, a manual manager section 220 making management of the manual data and instructing each element at subsequent stages related to display of the manual to display the manual when the user gives an instruction of displaying the manual on an operation screen, not illustrated, a manual composing section 230 composing the manual based on the manual data in response to an instruction from the manual manager section 220, and a manual display section 240 displaying the manual composed by the manual composing section 230 on the monitor of each client machine 200.

The contact center 30 corresponds to an example of the reception according to the basic aspect and the inquiry data receiving section 110 corresponds to an example of the inquiry data receiving section according to the basic aspect. Furthermore, the inquiry database 120 corresponds to an example of the inquiry recording section according to the basic aspect and the coordinating section 130 corresponds to an example of a combination of the count data generation section, the instruction signal receiving section and the count data transmission section according to the basic aspect. The manual data storage section 210 corresponds to an example of the data recording section according to the basic aspect. The manual manager section 220 corresponds to an example of a combination of the instruction signal transmission section, the count data receiving section and the arrangement order change section according to the basic aspect. A combination of the manual composing section 230 and the manual display section 240 corresponds to an example of the display section according to the basic aspect.

First, a basic manual display processing performed by the client machine 200 will be described.

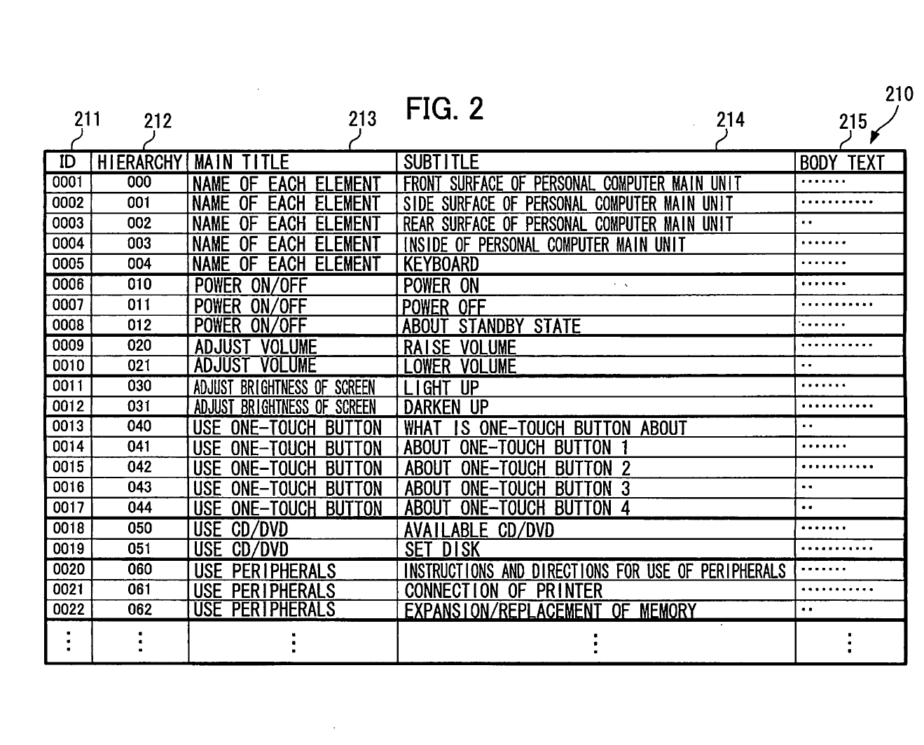

FIG. 2 is a diagram illustrating an example of manual data stored in the manual data storage section illustrated in FIG. 1.

In this embodiment, the manual represented by the manual data includes main titles each comprehensively illustrating explanatory items relating to how to handle the client machine 200 such as “NAME OF EACH ELEMENT” and “% POWER ON/OFF”, subtitles that are subheads such as “FRONT SURFACE OF PERSONAL COMPUTER MAIN BODY”, “SIDE SURFACE OF PERSONAL COMPUTER MAIN BODY” and “POWER ON” and main statements that are statements describing contents according to the respective subtitles. A set of one main title, plural subtitles and main statements relating to the respective subtitles that correspond to one explanatory item will be referred to as “explanatory statement”. This explanatory statement corresponds to an example of the explanatory statement according to the basic aspect.

This manual data representing the manual includes plural explanatory statement data representing explanatory statements, and plural pieces of hierarchical data (as described later) representing arrangement orders of the explanatory statements in the manual in an arrangement order hierarchically. Furthermore, in this embodiment, each hierarchical data is date representing not only the arrangement order of each explanatory statement in the arrangement order but also an arrangement order of a main statement constituting the explanatory statement. The explanatory statement data corresponds to an example of explanatory statement data according to the basic aspect and the hierarchical data corresponds to an example of arrangement order data according to the basic aspect.

The hierarchical data illustrates a arrangement order of each explanatory statement in the arrangement order and the arrangement number of each main statement in the explanatory statement by three-digit numbers such as “000” or “001”. First, higher-order two digits out of this three-digit number denote the arrangement order of the explanatory statement. Next, lower-order one digit out of the three-digit number of the hierarchical data denotes a local arrangement order of each main statement composing the explanatory statement in the explanatory statement. In this embodiment, a smaller number in each digit indicates a higher order.

This manual data storage section 210 includes a main statement ID storage section 211 storing therein plural pieces of main statement ID data that are serial numbers allocated to main statements for each of the main statements, a hierarchical data storage section 212 storing therein plural pieces of hierarchical data for each of the main statements, a main title storage section 213 storing therein data parts representing the main titles of the explanatory statement data for each of the main statements, a subtitle storage section 214 storing therein data parts representing the subtitles for the main statements and a main statement storage section 215 storing therein data parts representing the main statements for the main statements.

In this embodiment, the main titles, the subtitles and the main statements represented by the explanatory statement data are arranged according to hierarchies indicated by the respective hierarchical data, thereby composing the manual. Further, the composed manual is displayed on the monitor and presented to the user.

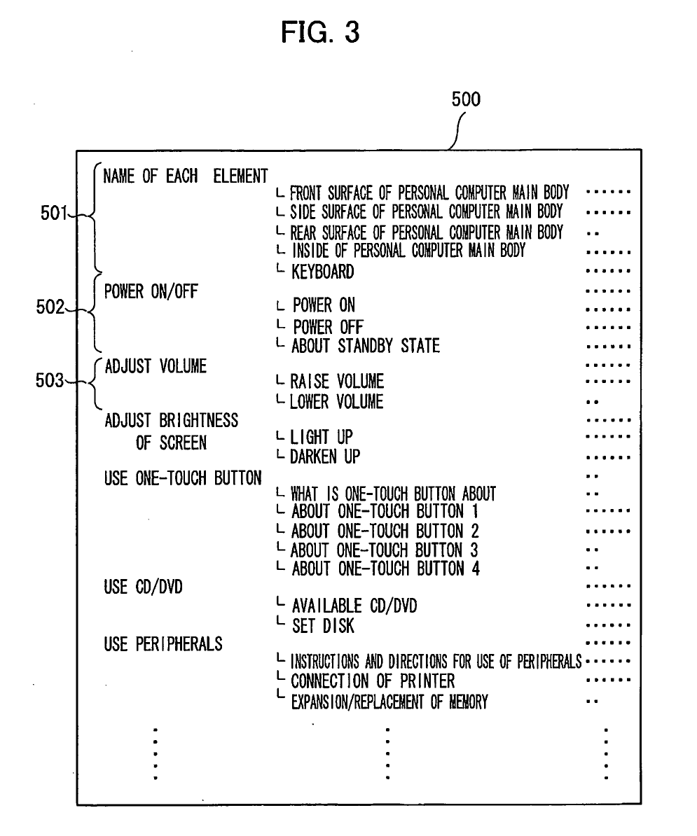

FIG. 3 is a diagram illustrating a manual composed based on the manual data illustrated in FIG. 2.

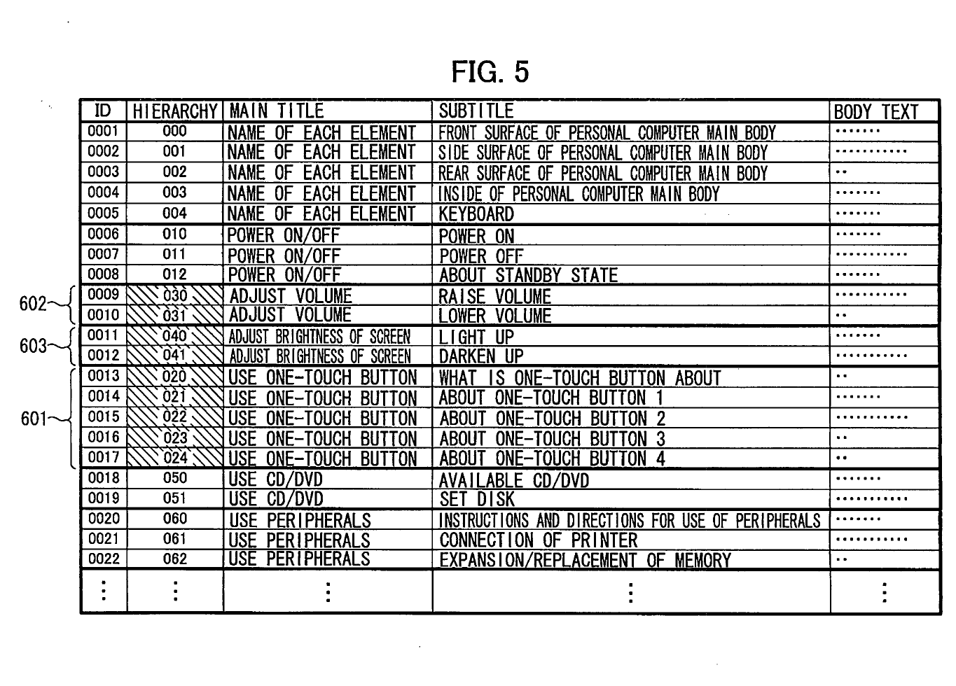

In a manual 500 illustrated in FIG. 3, a main statement constituting an explanatory statement 501 to which the main title “name of each element” is allocated and which includes hierarchical data the higher-order two-digit numbers of which are “00”, in the manual data stored in the manual data storage section 210 illustrated in FIG. 5, is described at a highest position together with the main title and the subtitles according to hierarchies represented by the hierarchical data. Body statements constituting plural explanatory statements such as an explanatory statement 502 to which the main title “turn on/off” is allocated and an explanatory statement 503 to which a main title “adjust volume” is allocated are described subsequently in the arrangement order according to magnitudes of higher-order two-digit numbers of the hierarchical data. Furthermore, in each explanatory statement, main statements are described together with the subtitles according to magnitudes of lowest-order digit numbers of the hierarchical data corresponding to the respective main statements.

In the manual 500 illustrated in FIG. 3, the arrangement order of the explanatory statements is a default arrangement order in which the explanatory statements relating to basic explanatory items such as the name of each element of the client machine 200 and how to turn on or off the client machine 200 are arranged at higher positions.

In this embodiment, a manufacturer of each client machine 200 stores default manual data including hierarchical data corresponding to the default arrangement order illustrated in FIG. 3 in the manual data storage section 210 of the client machine 200.

As described below, after shipping, whenever the client machine 200 is turned on, the hierarchical data included in the manual data stored in the manual data storage section 210 is updated according to degrees of interest of a user in the explanatory items relating to the respective main titles.

As already described, in this embodiment, an operator of the contact center 30 receives a user's inquiry for each client machine 200 through telephone or the like.

As described, in this embodiment, the user ID data for identifying each user is allocated to the user of each client machine 200 belonging to the client-server system 10 illustrated in FIG. 1. When each user inquires the operator in the contact center 30, the user is supposed to inform the operator of the user ID data.

In this embodiment, the inquiry data representing a content of an inquiry received in the contact center 30 as well as the user ID data for identifying the user who inquires the operator is transmitted to the server machine 100 by operator's operation from the computer, not illustrated, installed in the contact center 30. Furthermore, in this embodiment, when receiving the inquiry, the operator determines that the content of the inquiry relates to which explanatory item of the explanatory items with main titles attached thereto in the manual. Thus, the computer (not illustrated) in the contact center 30 transmits item data representing a determination result as well as the inquiry data and the user ID data to the server machine 100 by operator's operation. Moreover, in this embodiment, the computer transmits date data representing a date when the inquiry is made (inquiry date) as well as the inquiry data, the user ID data and the item data to the server machine 100. The inquiry data corresponds to one example of the inquiry data according to the basic aspect and the item data corresponds to one example of the item data according to the basic aspect.

The inquiry data receiving section 110 of the server machine 100 receives various pieces of data such as the inquiry data transmitted from the contact center 30. The inquiry data, user ID data, item data and date data thus received are stored in the inquiry database 120 while being associated with one another.

In this embodiment, how much interest a certain user feels in each explanatory item of the manual is determined by how many times the user has made inquires relating to the explanatory item. Namely, the explanatory item having a greater number of times of inquiries is considered to be an explanatory item in which the user is more interested. In this embodiment, whenever the client machine 200 is turned on, update processing of the hierarchical data is performed for the hierarchical data stored in the manual storage section 210 to move up the arrangement order of an explanatory statement of the explanatory item in which the user has great interest as a number of inquiries from the user of the client machine 200 is large.

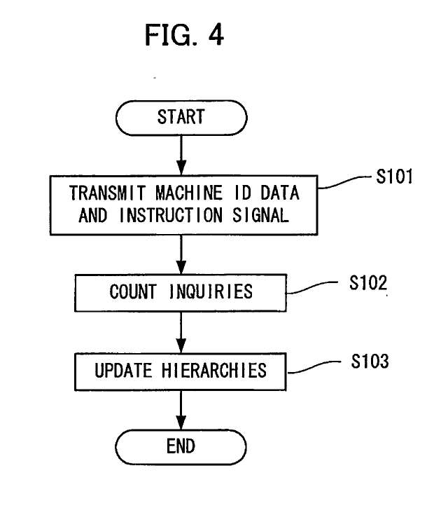

FIG. 4 is a flowchart illustrating the update process of updating the hierarchical data in the manual data stored in the manual data storage section illustrated in FIG. 1.

As described above, update process of updating the hierarchical data illustrated in the flowchart of FIG. 4 starts when the client machine 200 is turned on.

When the process illustrated in FIG. 4 starts, the manual manager section 220 of the client machine 200 that is turned on executes the following process including reading of the machine ID data from the memory, not illustrated, of the client machine 200 (step S101).

In the step S101, subsequently after reading of the machine ID data, the manual manager section 220 extracts a power-on date when the client machine 200 was previously turned on from an operation history of the client machine 200 recorded in the memory (not illustrated). Further, the manual manager section 220 generates an instruction signal for instructing the server machine 100 to transmit count data representing the number of times of user's inquiries for respective explanatory items within a period from the previous power-on date until a current power-on date. Moreover, the manual manager section 220 transmits the generated instruction signal and the machine ID data to the server machine 100. The count data corresponds to one example of the count data according to the basic aspect and the instruction signal corresponds to an example of the instruction signal according to the basic aspect.

In the server machine 100, the coordinating section 130 receives the instruction signal and the machine ID data. The coordinating section 130 first reads the user ID data associated with the received machine ID data from the memory (not illustrated) in the server machine 100. The coordinating section 130 searches the inquiry database 120 using the read user ID data and locates inquiry data and item data associated with the read user ID data and associated with inquiry dates after the previous power-on date and before the current power-on date. The coordinating section 130 classifies the located inquiry data according to the explanatory items for each of the explanatory items of the manual based on the located item data, and counts pieces of inquiry data classified for each of the explanatory items, thereby determining the number of times of inquiries for the respective explanatory items to generate count data representing the determined numbers of inquiries (step S102). By doing so, the coordinating section 130 generates the count data representing the number of inquiries from the user of this client machine 200 within the period from the previous power-on date until the current power-on date for each of the explanatory items of the manual.

In this embodiment, the count data representing the number of inquires for each explanatory item is easily generated by classification and counting based on the item data.

This indicates that it is preferable that the count data generation section generates, as the count data, data indicating a number of the inquiry data related to each of the plurality of explanatory items in each of the plurality of explanatory items in the basic aspect described above.

The coordinating section 130 according to this embodiment also corresponds to an example of the count data generation section according to the applied aspect.

The coordinating section 130 transmits the generated count data to the client machine 200 identified by the received machine ID data as well as the instruction signal.

The manual manager section 220 of the client machine 200 receives this count data.

In this embodiment, the manual manager section 220 has plural threshold values associated with the frequencies of moving up of the arrangement order in the manual, respectively. The manual manager section 220 compares the number of times of inquiries for each of the explanatory items indicated by the received count data with the threshold values, thereby determining the number of times of moving up of the arrangement order. Furthermore, the manual manager section 220 updates the hierarchical data in the manual data stored in the manual data storage section 210 based on the determined content (step S103).

For example, if the number of inquiries relating to a certain explanatory item is larger than the threshold value associated with the number of times of moving up of “2” and smaller than the threshold value associated with the number of times of moving up of “3”, the manual manager section 220 determines the number of times of moving up the arrangement order of the explanatory statement relating to the explanatory item to be “2”. In addition, the manual manager section 220 determines the number of times of moving up of the arrangement order of the explanatory statement relating to the explanatory item whose number of inquires is smaller than the smallest threshold value to be “0”.

If the number of times of moving up the arrangement order of each of the explanatory statements is thus determined, update process of the hierarchical data is performed as follows.

As described above, in this embodiment, the hierarchical data in the manual data represents the arrangement order of the explanatory statement relating to each explanatory item in the form of higher-order two-digit number out of the three-digit number.

In the embodiment, for the explanatory statement whose number of times of moving up is a value other than “0”, the number of times of moving up is subtracted from the higher-order two-digit number of the hierarchical data, thereby moving up the arrangement order of the explanatory statement. Furthermore, for the arrangement orders of other explanatory statements to which the arrangement orders between the arrangement order before moving up and the arrangement order after moving up are allocated, “1” is added to the higher-order two-digit number, thereby moving down the arrangement orders in the arrangement order and changing the arrangement.

In the processing of the step S103, moving up the arrangement order and the accompanied moving down thereof in the arrangement order are executed in a descending order of the arrangement orders before moving up for arrangement orders for the explanatory items whose frequencies of moving up are other than “0 ”. When the processing of this step S103 ends, the processing illustrated in the flowchart of FIG. 4 ends.

Thereafter, when the user gives an instruction of displaying the manual through an operation screen (not illustrated), the arrangement order of the explanatory statement corresponding to the explanatory item whose number of inquiries previously made by the user is larger and in which this user is greatly interest is moved up in the arrangement order than before to be emphatically displayed. This can facilitate user's referring to an explanation relating to the explanatory item in which the user is interested.

This indicates that it is preferable that the arrangement order change section moves up the sequence order according to the number of times in the basic aspect described above.

The manual manager section 220 that moves up the arrangement order of a certain explanatory item according to this embodiment as described above corresponds to an example of the arrangement order change section according to this applied aspect.

Next, the change of the arrangement order conceptually described above will next be explained while referring to a specific example.

The example to be described below is an example of changing the arrangement order by updating the hierarchical data in the default manual data illustrated in FIG. 2.

FIG. 5 is a diagram illustrating manual data after changing the arrangement order for the default manual data illustrated in FIG. 2 by updating the hierarchical data.

The example illustrated in FIG. 5 is an example in which the number of inquiries made by the user for an explanatory item 601 relating to a main title of “USE ONE-TOUCH BUTTON” within a period from a previous power-on date until a current power-on date is larger than the threshold value corresponding to the number of times of moving up of “2” and smaller than the threshold value corresponding to the number of times of moving up of “3” and in which the number of times of moving up the arrangement order of this explanatory item 601 in the arrangement order is determined to be “2”. Furthermore, in this example, the numbers of times for the other explanatory items are smaller than the minimum threshold values, respectively and the number of times of moving up the arrangement order of each of the other explanatory items is decided to “0”.

In the example of FIG. 5, the higher-order two-digit number “04” of the hierarchical data on the explanatory item 601 relating to the main title of “use one-touch button” before change (see FIG. 2) is subtracted by the determined number of moving up, that is, “2” and updated to “02”. By this update, the arrangement order of the explanatory statement relating to the explanatory item 601 is moved up by “2”.

Moreover, “1” is added to the higher-order two-digit number of each of the hierarchical data on an explanatory item 602 relating to the main title of “adjust volume” whose higher-order two-digit number of the hierarchical data is originally “02” and the hierarchical data on an explanatory item 603 relating to a main title of “adjust brightness of screen” whose the higher-order two-digit number of the hierarchical data is originally “03”, thereby moving down the arrangement order by “1.” In the example of FIG. 5, by updating the hierarchical data, the arrangement of the explanatory statement corresponding to the explanatory item 601 relating to the main title of “USE ONE-TOUCH BUTTON” and the arrangement order of the explanatory statement corresponding to the explanatory item 602 relating to the main title of “ADJUST VOLUME” of the explanatory statement corresponding to the explanatory item 603 relating to the main title of “adjust brightness of screen” are swapped to each other.

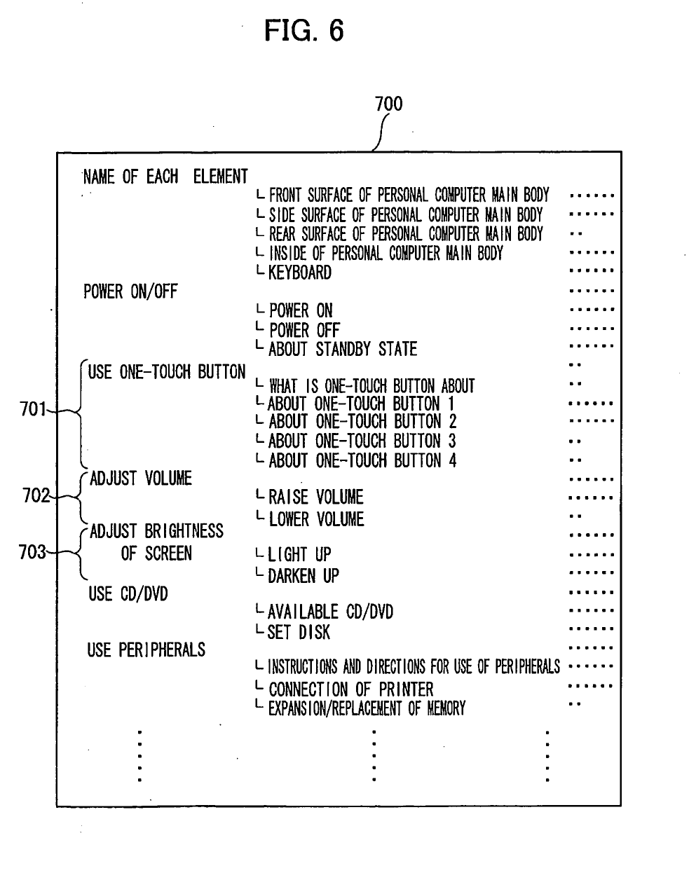

FIG. 6 is a diagram illustrating a manual composed based on the manual data after updating the hierarchical data illustrated in FIG. 5.

In a manual 700 illustrated in FIG. 6, an explanatory statement 701 of the main title of “use one-touch button” that is arranged in a fifth order in the manual 500 before updating illustrated in FIG. 3 is arranged in a third order by moving up the arrangement order by “2” according to the number of user's inquiries. Following this, an explanatory statement 702 of the main title of “adjust volume” arranged in a third order in the manual 500 before updating is arranged in a fourth order in the manual 700. Further, an explanatory statement 703 of the main title of “adjust brightness of screen” arranged in a fourth order in the manual 500 before update is arranged in a fifth order in the manual 700.

By such a change in the arrangement, the explanatory statement 701 of the main title of “use one-touch button” for which the user made many inquiries previously and in which the user is greatly interested is arranged at a higher position than before to be emphatically displayed. Therefore, the manual is displayed in a state in which the user can easily refer to the manual.

As described above, the client-server system 10 according to this embodiment can display a manual in which the arrangement of explanatory statements is updated according to the number of inquires previously made by each user and which is easy for the user to refer to, in the client machine 200.

The client-server system 10 displaying a manual for a computer is exemplified as the embodiment of the client-server system for which the basic aspect is described. However, the client-server system is not limited to this but may be applied to an ordinary electronic device such as a portable telephone capable of constituting a predetermined network.

Moreover, a change excited in the hierarchical data in the manual data when each client machine 200 is turned on is exemplified as the embodiment of the client-server system for which the basic aspect is described. However, the client-server system is not limited to this. For example, the client-server system may be configured, for example, such that the hierarchical data is changed when a user instructs display of a manual.

Furthermore, determining the number of times of inquiries for each client machine 200 in the period from the previous power-on date until the current power-on date is exemplified as the embodiment of the client-server system for which the basic aspect is described. However, the client-server system is not limited to this. Alternatively, the client-server system may be configured, for example, to determine an accumulated number of times until the current power-on date. In this alternative, initial hierarchical data is stored and an update processing is performed on this initial hierarchical data according to the accumulated number of times whenever the power is turned on.

As described above, the present invention can provide an electronic manual system facilitating user's referring to a manual.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A client-server system comprising:
a client machine that performs a process in response to an operation of a user; and
a server machine that is capable of communicating with the client machine,
wherein the server machine includes:
an inquiry data receiving section that receives, from a reception which receives an inquiry about how to handle the client machine from a user of the client machine, inquiry data representing a content of the inquiry, item data indicating which explanatory item of a plurality of explanatory items in a manual the inquiry relates to, the manual explaining how to handle the client machine, and client link data leading to an identification of the client machine;
an inquiry recording section that records the inquiry data with the item data and the client link data such that the inquiry data, the item data and the client link data are associated to one another;
a count data generation section that generates count data indicating a number of times of the inquiry for each of the plurality of explanatory items with respect to the client machine based on the inquiry data, the item data and the client link data;
an instruction signal receiving section that receives from the client machine an instruction signal which instructs transmission of the count data with respect to the client machine identified by the client link data, together with data which identifies the client machine; and
a count data transmission section that transmits the count data to the client machine identified by the client link data, and
wherein the client machine includes:
a data recording section that records explanatory statement data representing respective explanatory statements in each of the plurality of explanatory items and arrangement order data representing an arrangement order of each of the explanatory statements;
a display section that displays the explanatory statements each represented by the respective explanatory statement data according to the arrangement order represented by the arrangement order data;
an instruction signal transmission section that generates the instruction signal and transmits the instruction signal to the server machine, while identifying the client machine itself;
a count data receiving section that receives the count data transmitted from the server machine according to the instruction signal; and
an arrangement order change section that changes the arrangement order data in the data recording section to the arrangement order data representing an arrangement order according to the number of times represented by the count data.

2. The client-server system according to claim 1,
wherein the count data generation section generates, as the count data, data indicating a number of the inquiry data related to each of the plurality of explanatory items in each of the plurality of explanatory items.

3. The client-server system according to claim 1,
wherein the arrangement order change section moves up the sequence order according to the number of times.

4. A server machine capable of communicating with a user machine which performs a process in response to an operation of a user, comprising:
an inquiry data receiving section that receives, from a reception which receives an inquiry about how to handle the user machine from a user of the user machine, inquiry data representing a content of the inquiry, item data indicating which explanatory item of a plurality of explanatory items in a manual the inquiry relates to, the manual explaining how to handle the user machine, and link data leading to an identification of the user machine;
an inquiry recording section that records the inquiry data with the item data and the link data such that the inquiry data, the item data and the link data are associated to one another;
a count data generation section that generates count data indicating a number of times of the inquiry for each of the plurality of explanatory items with respect to the user machine based on the inquiry data, the item data and the link data;
an instruction signal receiving section that receives from the user machine an instruction signal which instructs transmission of the count data with respect to the user machine identified by the link data, together with data which identifies the user machine; and
a count data transmission section that transmits the count data to the user machine, the user machine including a data recording section which records explanatory statement data representing respective explanatory statements in each of the plurality of explanatory items and arrangement order data representing an arrangement order of each of the explanatory statements; a display section which displays the explanatory statements each represented by the respective explanatory statement data according to the arrangement order represented by the arrangement order data; and an arrangement order change section which changes the arrangement order data in the data recording section to the arrangement order data representing an arrangement order according to the number of times represented by the count data.
